(19) United States
(12) Patent Application Publication
(10) Pub. No.: US 2017/0076752 A1
(43) Pub. Date: Mar. 16, 2017

(54) SYSTEM AND METHOD FOR AUTOMATIC MEDIA COMPILATION

(71) Applicant: Laura Steward, Kansas City, MO (US)

(72) Inventor: Laura Steward, Kansas City, MO (US)

(21) Appl. No.: 15/261,278

(22) Filed: Sep. 9, 2016

Related U.S. Application Data
(60) Provisional application No. 62/216,798, filed on Sep. 10, 2015.

(51) Int. Cl. G11B 27/031; G11B 27/00; H04N 21/218; H04N 21/8549; H04N 21/84; H04N 21/2743; H04N 21/858; G11B 27/10

(52) U.S. Cl. CPC G11B 27/031; H04N 21/8586; G11B 27/002; G11B 27/10; H04N 21/8549; H04N 21/84; H04N 21/2743; H04N 21/218

(57) ABSTRACT

A system includes at least one processor to execute instructions stored in a memory to perform operations including receiving a request to create a media file from a first client computing device associated with a producer of the media file and storing a representation of the media file in a database, creating a unique code that represents the media file and storing the unique code in the database with the representation of the media file, receiving the unique code and a media component from an actor invited to submit a contribution to the media file, the media component sent by a second client computing device, storing the media component in the database with the representation of the media file, automatically compiling the media component into a final media file, and sending a notification to a recipient client computing device that the final media file is ready for viewing.

### CROSS-REFERENCE TO RELATED APPLICATIONS

This application is related to and claims priority under 35 U.S.C. §119(e) from U.S. Patent Application No. 62/216,798, filed Sep. 10, 2015 entitled “System and Method for Automatic Media Compilation,” the entire contents of which is incorporated herein by reference.

### FIELD

The described embodiments relate generally to automatic media compilation. More particularly, the embodiments relate to creation of a media file, the media file having one or more media components submitted by one or more users.

### BACKGROUND

Computing devices have gradually become ubiquitous and a part of daily life. Users of smartphones and tablets have access to a portable device that is capable of communicating with others, capable of executing applications, and capable of sending information to other devices and receiving information from other devices. In one example, people use their smartphones to capture photographs and video associated with their daily life.

Greeting cards are used much less frequently to express feelings and send messages to others. However, people desire to connect with others and create something personal that may be shared. Today, computing devices are used to communicate with others throughout the world.

While it is easy to capture photographs and video using a smartphone, it is difficult to compile and curate photographs and videos from others, especially using a smartphone. For example, a plurality of people may send photographs and videos to one point person via text message or email. The media files associated with the photographs and videos may be large and may require the use of intermediary platforms including web-based file hosting services such as Dropbox™ and/or compression. As a result, the media may have reduced quality. It is prohibitively difficult for most people to collect digital assets from others and create a video message or collect personal video messages from others without significant effort and/or financial cost. In many instances, expensive software and/or hardware may be necessary.

It is with these issues in mind, among others, that various aspects of the disclosure were conceived.

### SUMMARY

According to one aspect, an automatic media compilation system is provided for creating a media file by a media producer using a computing device, inviting at least one actor to submit a contribution to the media file using another computing device, receiving one or more contributions from the at least one actor and storing the contributions in a database, and automatically compiling the one or more contributions into a final published media file by a server computing device for distribution to a recipient.

According to one embodiment, a system includes a memory and at least one processor to execute instructions stored in the memory to perform operations including receiving a request to create a media file from a first client computing device associated with a producer of the media file and storing a representation of the media file in a database, creating a unique code that represents the media file and storing the unique code in the database with the representation of the media file, receiving the unique code and a media component from an actor invited to submit a contribution to the media file, the media component sent by a second client computing device, storing the media component in the database with the representation of the media file, automatically compiling the media component into a final media file, and sending a notification to a recipient client computing device that the final media file is ready for viewing.

According to a further embodiment, a method includes receiving, by at least one processor, a request to create a media file from a first client computing device associated with a producer of the media file and storing a representation of the media file in a database, creating, by the at least one processor, a unique code that represents the media file and storing the unique code in the database with the representation of the media file, receiving, by the at least one processor, the unique code and a media component from an actor invited to submit a contribution to the media file, the media component sent by a second client computing device, storing, by the at least one processor, the media component in the database with the representation of the media file, automatically compiling, by the at least one processor, the media component into a final media file, and sending, by the at least one processor, a notification to a recipient client computing device that the final media file is ready for viewing.

According to another embodiment, a non-transitory computer-readable medium includes instructions stored thereon that, when executed by a processor, causes the processor to perform operations including receiving a request to create a media file from a first client computing device associated with a producer of the media file and storing a representation of the media file in a database, creating a unique code that represents the media file and storing the unique code in the database with the representation of the media file, receiving the unique code and a media component from an actor invited to submit a contribution to the media file, the media component sent by a second client computing device, storing the media component in the database with the representation of the media file, automatically compiling the media component into a final media file, and sending a notification to a recipient client computing device that the final media file is ready for viewing.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of an automatic media compilation system according to an example embodiment.

FIG. 2 illustrates a block diagram of a client computing device of the system according to an example embodiment.

FIG. 3 illustrates a block diagram of a server computing device of the system according to an example embodiment.

FIG. 4 illustrates a database table of the system according to an example embodiment.

FIG. 5 illustrates a flowchart of a process for creating a media file by the system according to an example embodiment.

FIGS. 6-13 illustrate example screenshots of user interfaces of an automatic media compilation application according to an example embodiment.

FIG. 14 illustrates a block diagram of an example computer device for use with the example embodiments.

### DETAILED DESCRIPTION

For the purpose of promoting an understanding of the principles of the present disclosure, reference will now be made to the embodiments illustrated in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

The client computing devices and the server computing device communicate over a communications network using Hypertext Transfer Protocol (HTTP) and/or other communications protocols. HTTP provides a request-response protocol in the client-server computing model. A client application running on the client computing device may be a client and a server application running on the server computing device may be the server, e.g., a web server. The client submits, for example, an HTTP request to the server. The web server of the server computing device provides resources, such as Hypertext Markup Language (HTML) files and/or other content, and performs other functions on behalf of the client, and returns an HTTP response message to the client. Other types of communications using different protocols may be used in other examples.

The one or more computing devices may communicate based on representational state transfer (REST) and/or Simple Object Access Protocol (SOAP). As an example, a first computer (e.g., a client computer) may send a request message that is a REST and/or a SOAP request formatted using Javascript Object Notation (JSON) and/or Extensible Markup Language (XML). In response to the request message, a second computer (e.g., a server computer) may transmit a REST and/or SOAP response formatted using JSON and/or XML.

Aspects of a system and method for automatic media compilation provide a client application for creating contributions comprising media components and submitting contributions to a media file and a server application for receiving the contributions and automatically compiling the contributions into a final published media file for distribution to a recipient. For example, a producer may create a birthday media file comprising a video compilation for distribution to a particular recipient and invite one or more actors to submit their contributions to the birthday media file using the client application. Each of the one or more actors may receive an electronic invitation (e.g., a text message, a push notification, and/or an email) to record a video message using their smartphone. The client application may be executed by a smartphone.

Each of the one or more actors may use their personal smartphones to create a media component such as a video contribution, an audio contribution, a photographic contribution, a text contribution, or another type of contribution and submit their contribution to a server. The server receives the one or more contributions and automatically compiles and creates a final media file. When all of the contributions are recorded, the producer may choose to deliver the final media file or schedule delivery of the final media file. The server may notify the producer that the final media file is ready for distribution to the particular recipient. The server may receive a finalization request for the media file from the producer or may finalize the media file at a particular time, and may transmit a representation of the final media file. The final media file may be streamed to recipients via a communications network, stored in memory of a smartphone of the recipient or a computer of the recipient, shared using social media, or may be stored on a recordable medium (e.g., a DVD or Blu-ray) for physical distribution to the recipient.

The producer may select attractive themes that include personalized video animations to be shown at a beginning of the final media file and may insert text into the final media file. The text may be title information, recipient information, and/or associated with the one or more contributions. The media file may be a customized greeting for any occasion, including but not limited to a video production for a commercial use or a conference, occasion creations for weddings, birthdays, anniversaries, engagements, congratulations, get well wishes, graduations, new baby, remembrance or sympathy, and thinking of you. The media file may be used to remember, document, or celebrate any occasion, celebration, or holiday.

According to an exemplary embodiment, each actor may use the client application to spend a few seconds or minutes to collectively participate in creating in a special message for the final media file that may be cherished and/or remembered forever by the recipient.

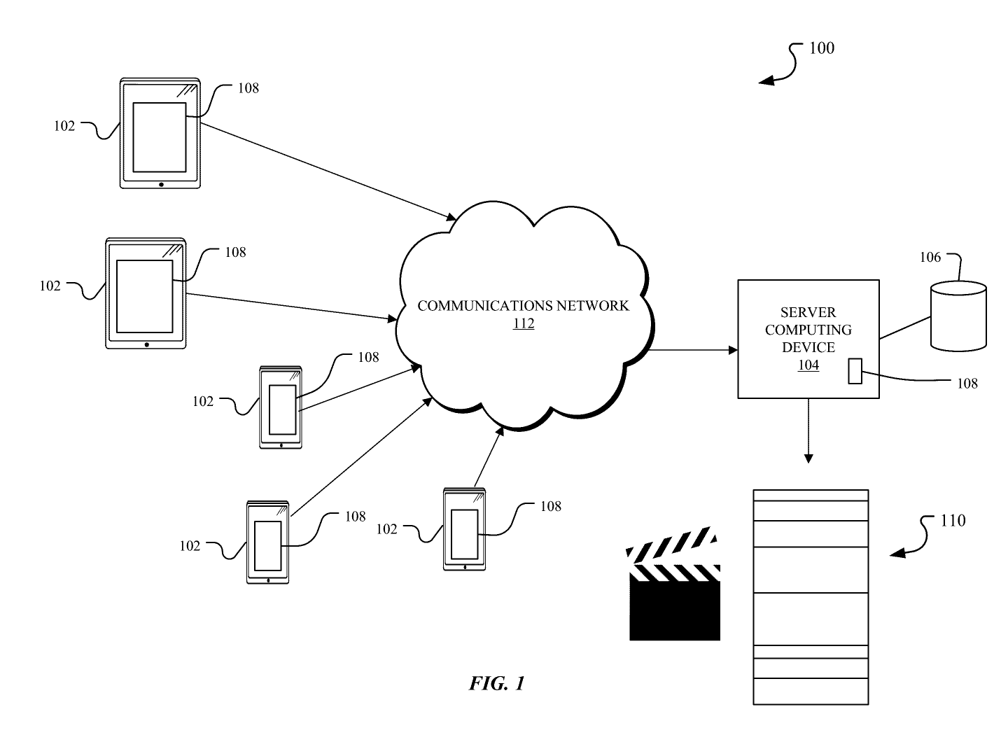

FIG. 1 shows a block diagram of a computing system that includes an automatic media compilation system 100 according to an example embodiment. The automatic media compilation system 100 includes at least one client computing device 102 that is in communication with at least one server computing device 104 via a communications network 112. The at least one client computing device 102 may have a client component of an automatic media compilation application 108 and the at least one server computing device may have a server component of the automatic media compilation application 108 that communicates with at least one database 106 that comprises a non-relational database and/or a relational database for storing media components, e.g., contributions, and final media files 110, among other data. As an example, the information may be stored in a relational database management system (RDBMS), an open source distributed database management system such as a Not only SQL (NoSQL) database management system, an in-memory database (IMDB) management system, or another appropriate database management system. As an example, the contributions may be stored in the at least one database 106, the final media files 110 may be stored in the at least one database 106, and producer/actor application authentication information (e.g., username/password information) may be stored in the at least one database 106. Each media file may have a particular identifier that is used to reference the media file in the database 106.

The at least one server computing device 104 is configured to receive data from and/or transmit data to the at least one client computing device 102 through the communications network 112. Although the at least one server computing device 104 is shown as a single server, it is contemplated that the at least one server computing device 104 may include multiple servers, for example, in a cloud computing configuration.

The one or more computing devices communicate and coordinate their actions by passing messages over the communications network 112. The communications network 112 can be one or more of the Internet, an intranet, a cellular communications network, a WiFi network, a packet network, or another wired and/or wireless communication network or a combination of any of the foregoing. As an example, the one or more computing devices communicate data in packets, messages, or other communications using a common protocol, e.g., Hypertext Transfer Protocol (HTTP) and/or Hypertext Transfer Protocol Secure (HTTPS). As an example, the automatic media compilation system 100 may be a cloud-based computer system or a distributed computer system.

The automatic media compilation application 108 may be a component of an application and/or service executable by the client computing device 102 and/or the server computing device 104. For example, the automatic media compilation application 108 may be a single unit of deployable executable code or a plurality of units of deployable executable code. According to one aspect, the automatic media compilation application 108 may be a web application, a native application, and/or a mobile application (e.g., an app) downloaded from a digital distribution application platform that allows users to browse and download applications developed with mobile software development kits (SDKs) including the App Store and GOOGLE PLAY®, among others. The automatic media compilation application 108 may be installed on the client computing device 102, which may have the iOS operating system or an ANDROID™ operating system, among other operating systems. In an exemplary embodiment, the automatic media compilation application 108 may include a first client component executed by the client computing device 102 and a second server component executed by the at least one server computing device 104.

A producer begins by creating a media file, also known as a fizz. The producer may download the first client component of the automatic media compilation application 108, create a user account, and select a theme or template for the media file. The producer may create the account before or after creating the media file. Information associated with the account may be stored in the database 106. Next, the producer may enter media file details including name information for a recipient, a due date for contributions, a release date, participants and contact information for the participants (actors) for the media file, media file recipient contact information (e.g., an email address), and may record a contribution for the media file. The producer's client computing device transmits the media file details and the contribution to the server computing device 104 and the server computing device 104 stores the media file details and the contribution in the database 106. In one example, each media file may have a particular unique identifier (e.g., invitation code) that is used to query information from the database 106 and store information associated with the media file in the database 106. At this point, the server computing device 104 notifies each of the actors that they are invited to contribute to the media file. In one example, the notification may be a text message, a push notification, or an email sent to each of the actors.

According to an example embodiment, each actor may download the first client component of the automatic media compilation application 108 and record a contribution for the media file. Each actor may create an account and information associated with the account (e.g., a representation of a username and a representation of a password) may be stored in the database 106. The actor's client computing device transmits the contribution to the server computing device 104 and the server computing device 104 stores the contribution in the database 106. The client component of the automatic media compilation application 108 and/or the server component of the automatic media compilation application 108 ensures that each actor captures the contribution at the same angle (e.g., portrait or landscape) and a particular aspect ratio for consistent presentation of the media file. These may be based on the contribution from the producer and/or the details provided by the producer.

Once the contributions from the actors are received and stored in the database 106 by the server computer 104 or a deadline has passed for contributions, the server computing device 104 may notify the producer that the media file is ready for finalization and compilation. The producer may preview the media file including one or more contributions and may reorder/delete the contributions before the server computing device 104 finalizes the media file. Once the media file is ready for finalization, the server computer 104 at least one of combines the contributions, adds animations to custom text, adds animations to the contributions, automatically adjusts music based on the contributions, and stores the finalized media file in the database 106. The contributions and other information associated with the media file (e.g., text, animations, music) may be combined by the server computing device 104 and/or another computing device using utilities including cat, FFmpeg, and/or other related utilities. After the media file is finalized, the server computing device 104 notifies at least one of the producer, actors, and the recipient that the media file is ready for viewing. In one example, a uniform resource locator (URL) or a representation of the URL associated with the media file may be sent to the at least one of the producer, the actors, and the recipient. In one example, the representation of the URL may be sent via a push notification.

The server computer 104 may provide delayed delivery of the finalized media file as an option. When creating a media file, the producer may select a particular time for delivery of the media file, e.g., a wedding date in the future or a birthday in the future. At the particular time, the server computer 104 transmits a message or communication to the recipient that indicates that the media file is ready for viewing. The recipient may view the media file at the particular time using a recipient client computer. The recipient may be the producer and/or an actor. The recipient may download the client component of the automatic media compilation application 108 to view the media file or may view the media file using a web browser or another application. Additionally, the recipient may create an account and information associated with the account may be stored in the database 110.

While a media file is in the process of being edited by the producers and/or the actors, the media file and its associated media components may be stored within the database 106. After the media file is finalized, the media file may be stored on a content delivery network (CDN), e.g., Amazon S3™, associated with the automatic media compilation system 100 and/or in the database 106.

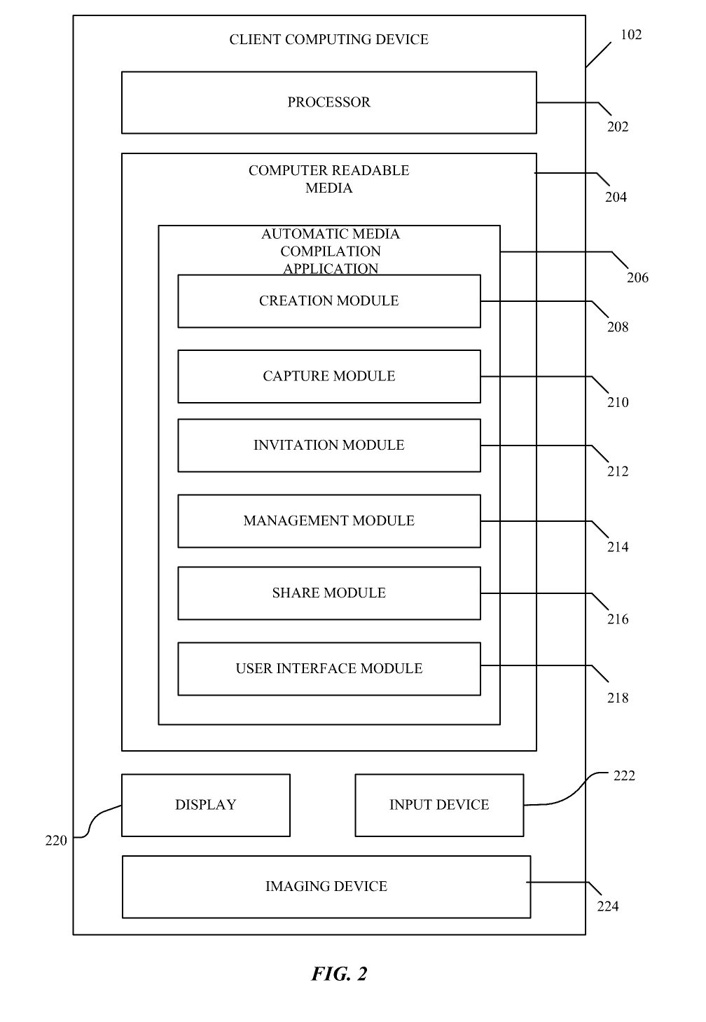

FIG. 2 illustrates a block diagram of the client computing device 102 according to an example embodiment. The client computing device 102 may be a computer having a processor 202 and memory, such as a laptop, desktop, tablet computer, mobile computing device (e.g., a smartphone), or a dedicated electronic device having a processor and memory. The one or more processors 202 process machine/computer-readable executable instructions and data, and the memory stores machine/computer-readable executable instructions and data including one or more applications, including a client component of an automatic media compilation application 206. The processor 202 and memory are hardware. The memory includes random access memory (RAM) and non-transitory memory, e.g., a non-transitory computer-readable storage medium such as one or more flash storages or hard drives. The non-transitory memory may include any tangible computer-readable medium including, for example, magnetic and/or optical disks, flash drives, and the like. Additionally, the memory may also include a dedicated file server having one or more dedicated processors, random access memory (RAM), a Redundant Array of Inexpensive/Independent Disks (RAID) hard drive configuration, and an Ethernet interface or other communication interface, among other components.

The client computing device 102 uses the automatic media compilation application 206 to transmit data and messages and receive messages, data, and/or resources from the one or more server computing devices 104. The automatic media compilation application 206 provides an interface to create and view media.

In order to obtain access to protected resources associated with the server computing device 104, e.g., resources stored in the database 106, the client computing device 102 optionally may transmit a request or other communication, such as with a representation of a username and a password, to the server computing device 104 using lightweight directory access protocol (LDAP), HTTP, hypertext transport protocol secure (HTTPS) and/or other protocols. The request may be a LDAP request, a representational state transfer (REST) request, a Simple Object Access Protocol (SOAP) request, or another type of request. The server computing device 104 optionally verifies the username and password and transmits a response or other communication to the client computing device 102 or otherwise grants access to the client computing device to create and view media. The server computing device 104 may transmit an HTTP response, an HTTPS response, a LDAP response, a REST response, a SOAP response, and/or another type of response.

The username and password may be encrypted by the client computing device 102 using transport layer security (TLS), secure sockets layer (SSL), and/or other encryption protocols. The username and password may be encrypted using a cryptographic hash function (e.g., SHA-1, MD5, and others) to determine a hash-based message authentication code (HMAC) (hash-based message authentication code). In one example, “username.password” is encrypted using the cryptographic hash function. This cryptographic hash function allows the username and password to be verified and authenticated by the server computing device 104 without directly sending the username and password to the server computing device via the communications network 112.

The automatic media compilation application 206 may be a component of an application and/or service executable by the client computing device 102. For example, the automatic media compilation application 206 may be a single unit of deployable executable code. The automatic media compilation application 206 may be one application and/or a suite of applications. According to an example embodiment, the automatic media compilation application 206 may be a native application or a mobile application (e.g., an app) downloaded from a digital distribution application platform that allows users to browse and download applications developed with mobile software development kits (SDKs) including the App Store and GOOGLE PLAY® among others. The app may be installed on the client computing device 102, which may have the iOS operating system or an ANDROID™ operating system, among other operating systems. The automatic media compilation application 206 communicates messages to the server computing device 104 and receives messages from the server computing device, e.g., HTTP requests and corresponding HTTP responses. The responses may comprise requested content.

The client computing device 102 further includes a display 220 and an input device 222. The display 220 is used to display visual components of the automatic media compilation application 206, such as at a user interface. In one example, the user interface may display a user interface of the automatic media compilation application 206, and a representation of the requested resources received from the server computing device 104. The display 220 can include a cathode-ray tube display, a liquid-crystal display, a light-emitting diode display, a touch screen display, and/or other displays. The input device 222 is used to interact with the automatic media compilation application 206 or otherwise provide inputs to the client computing device 102 and may include a mouse, a keyboard, a trackpad, and/or the like. The input device 222 may be included within the display 220 if the display is a touch screen display. The input device 222 allows a user of the client computing device 102 to manipulate the user interface of the automatic media compilation application 206 or otherwise provide inputs to be transmitted to the server computing device 104.

Additionally, the client computing device 102 may include an imaging device 224 for capturing video and/or still images, e.g., a media component or contribution, an optional sound device for providing audio output that may be associated with a notification provided by the server computing device 104 and received by the automatic media compilation application 206 or other user interface or application and an optional vibration motor for providing vibration feedback that may be associated with a notification provided by the server computing device 104 and received by the automatic media compilation application 206.

The client computing device 102 includes computer readable media (CRM) 204 in memory on which the automatic media compilation application 206 or other user interface or application is stored. The computer readable media may include volatile media, nonvolatile media, removable media, non-removable media, and/or another available medium that can be accessed by the processor 202. By way of example and not limitation, the computer readable media comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

The automatic media compilation application 206 includes a creation module 208 for creating a new media file, e.g., a fizz, to be shared with a recipient. The creation module 208 may determine a plurality of different media type templates or media file template categories and generate a list of the different media file categories/templates that may be used to create the media file. As an example, the media file template categories may be based on different occasions and may include “What's New,” “Most Popular,” “Free,” “Anniversary,” “Baby,” “Birthday,” “Cancer Sucks,” “Congratulations,” “Engagement/Wedding,” “Get Well Soon,” “Good Luck,” “Graduation,” “Military Heroes,” “Retirement,” “Thank You,” and “Thinking of You,” among others. Each media file template may have associated music, an introduction video, and/or associated text. The associated music may play for the duration of the media file and may loop if the music is shorter than an entire duration of the media file including its media components. The music audio level may duck or be lowered during each media component if the media component includes audio.

The user may select a media file template category and a list of available media file templates may be determined by the creation module 208. A user, or a producer of a media file selects a user interface element associated with one of these different media file templates to begin creation of the media file. Some of the media file templates may be free templates that may be used to create a free media file and some of the media file templates may be used to create a media file that may be purchased by the user. When the media file template is selected, the user may purchase the media file template and begin to create the media file. Each different media file template may be associated with a particular in-app purchase. Alternatively, the user may purchase an in-app purchase that allows the user to create an unlimited number of media files using any of the media file templates for a particular period of time, e.g., one year. The creation module 208 may send in-app purchase information, e.g., payment information, to the server computing device 104 and/or another server computing device. The payment information may be authorized and validated to purchase the media file template. Once the user purchases the media file template, the user may provide a name of the recipient of the media file, a description of the media file (e.g., “For those of you who can't make it to our wedding, we would like you to have you send your message through this amazing app—thanks so much and sorry we missed you”), a creator of the media file and actors or contributors to the media file, a date that the media file may be finalized by the server computing device 104, and a release date for the media file. After this information is provided, the client computing device 102 may transmit information associated with the new media file to the server computing device 104 and the information may be stored in the database 106.

The producer of the media file may add one or more image files to the media file, may add one or more audio files to the media file, and/or may add one or more video files to the media file. The capture module 210 of the automatic media compilation application may be used to capture the media components and/or may be used to find and upload the media components to the server computing device 104. A user may select a “Record Now” user interface element to begin capturing a video, audio, an image, or another media component using the imaging device 224 of the client computing device 102. The capture module 210 may receive orientation information from the server computing device 104 and ensure that the actor captures the media component at the same angle (e.g., portrait or landscape) as other media components and a particular aspect ratio for consistent presentation throughout the media file. The media components may be stored in the memory of the client computing device 102 or may be stored in another location. The capture module 210 transmits the media component to the server computing device 104 and the server component device 104 stores and associates the media component with the media file. After the media file is created and the producer is given the opportunity to add media components, the producer may invite one or more other users or actors to add a media component to the media file.

The automatic media compilation application 206 includes an invitation module 212 to invite the one or more other users or actors. When the media file is created, the server computing device 104 and/or the client computing device 102 may generate a unique representation for the media file. The unique representation may be an alphanumeric code that represents the media file. As an example, the unique representation may be “ABC12.” After the producer has created the media file, the producer may input contact information for one or more actors that may be invited to contribute one or more media components to the media file. The contact information may be obtained from a list of contacts available from memory of the client computing device 102. The invitation module 212 may generate and send a message that provides the unique representation for the media file. The message may be a text message, an email message, or another type of message. After entering the unique representation to the automatic media compilation application 206, each actor may add one or more image files, one or more audio files, and/or one or more video files to the media file using the capture module 210.

The automatic media compilation application 206 includes a management module 214 that allows the producer or another user to manage the media file. The management module 214 may allow the user to view how many of the invited actors have submitted one or more media components, delete one or more of the media components of the media file, reorder the media components of the media file, record another media component, invite more actors or remind the actors that have not submitted a media component. In addition, the management module 214 allows the user to finalize or finish the media file. When the user finalizes the media file, the client computing device 102 transmits a message to the server computing device 104 that notifies the server computing device 104 that the media file is to be finalized.

The automatic media compilation application 206 additionally includes a share module 216 that allows the user, e.g., the producer, an actor, or the recipient, to share a finalized media file. In one example, the user may share the finalized media file by sending a message to one or more recipients. The message may be a text message, an email message, or another type of message that provides a uniform resource locator (URL) of the finalized media file. Additionally, the user may use the share module 216 to store the finalized media file in memory and share the finalized media file via one or more social networks such as YouTube™, Facebook™, and Twitter™, among others.

The automatic media compilation application 206 includes a user interface module 218 for displaying a user interface on the display 220. As an example, the user interface module 218 generates a native and/or web-based graphical user interface (GUI) that accepts input and provides output viewed by users of the client computing device 102. The client computing device 102 may provide realtime automatically and dynamically refreshed automatic media compilation information. The user interface module 218 may send data to other modules of the automatic media compilation application 206 of the client computing device 102, and retrieve data from other modules of the automatic media compilation application 206 of the client computing device 102 asynchronously without interfering with the display and behavior of the user interface displayed by the client computing device 102.

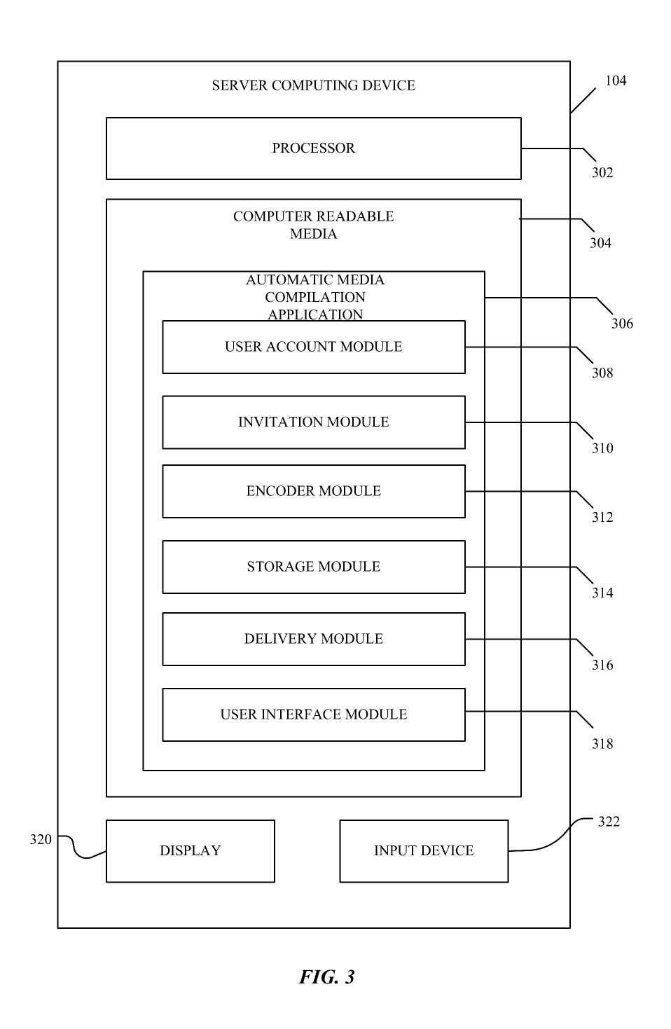

FIG. 3 illustrates a block diagram of the server computing device 104 according to an example embodiment. The server computing device 104 may be a computer having a processor 302 and memory, such as a server, laptop, desktop, tablet computer, mobile computing device (e.g., a smartphone), or a dedicated electronic device having a processor and memory. The one or more processors 302 process machine/computer-readable executable instructions and data, and the memory stores machine/computer-readable executable instructions and data including one or more applications, including a server component of the automatic media compilation application 306. The processor 302 and memory are hardware. The memory includes random access memory (RAM) and non-transitory memory, e.g., a non-transitory computer-readable storage medium such as one or more flash storages or hard drives. The non-transitory memory may include any tangible computer-readable medium including, for example, magnetic and/or optical disks, flash drives, and the like. Additionally, the memory may also include a dedicated file server having one or more dedicated processors, random access memory (RAM), a Redundant Array of Inexpensive/Independent Disks (RAID) hard drive configuration, and an Ethernet interface or other communication interface, among other components.

The server computing device 104 may include an optional display 320 and an optional input device 322. The display 320 displays visual components of the server component of the automatic media compilation application 306, such as at a user interface, if applicable. The display 320 can include a cathode-ray tube display, a liquid crystal display, a light-emitting diode display, a touch screen display, and/or other displays. The input device 322 is used to interact with the server component of the automatic media compilation application 306 and may include a mouse, a keyboard, a trackpad, and/or the like. The input device 322 may be included within the display 320 if the display is a touch screen display. The input device 322 allows a user of the server computing device 104 to manipulate the user interface of the automatic media compilation application 306.

The server computing device 104 includes computer readable media (CRM) 304 in memory on which the server component of the automatic media compilation 306 is stored. The computer readable media 304 may include volatile media, nonvolatile media, removable media, non-removable media, and/or another available medium that can be accessed by the processor 302. By way of example and not limitation, the computer readable media 304 comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

The automatic media compilation application 306 includes a user account module 308 for receiving, storing, verifying, and resetting information associated with accounts for using the automatic media compilation system 100. The information associated with the accounts may include username and password information, address information, payment information, and contact information, among other information. When a user, including producers and actors, first use the automatic media compilation application 206, the user is asked to create a user account. The user may input a username such as an email address and a password and transmit this information to the automatic media compilation application 306. The user account module 308 stores a representation of this information in the database 106. After the user account is created, when the client computing device 102 opens the automatic media compilation application 206, a representation of the username and a representation of the password is transmitted to the server computing device 104. The server computing device 104 verifies the username and password upon receipt and determines whether the user is an authorized user of the automatic media compilation application 206.

The user account module 308 may provide an interface for resetting password information associated with a particular user account. If a user is unable to provide a correct password after a particular number of incorrect attempts or the password is unknown, the user account module 308 may send a “Forgot Password” message to the automatic media compilation application 206 and display a “Forgot Password” user interface. The user may submit a request that the server computing device 104 reset the password associated with the user account and send an email to an email address associated with the user account including a one-time use URL that when selected, displays a web-based user interface allowing the user to reset their password and create a new password for use with the user account. The user account module 308 also may reset the password in other ways.

The automatic media compilation application 306 includes an invitation module 310 that creates a unique representation for each media file when created. When the media file is created, the server computing device 104 and/or the client computing device 102 may generate a unique representation or code for the media file. The unique representation may be the alphanumeric code that represents the media file. As an example, the unique representation may be “ABC12.” The invitation module 310 may store the alphanumeric code in a row in the database 106 along with any other associated information such as producer information, actor information, and date information such as a media file finalization date and a media file release date.

The automatic media compilation application 306 additionally includes an encoder module 312 that periodically runs a background process to determine whether there are one or more media files ready in a queue that are to be finalized. As an example, this background process may run at a particular interval of time, e.g., once a minute. The encoder module 312 may determine the media components associated with the media file to be finalized and an order of the media components. The encoder module 312 may encode the media file in a particular format, such as an H.264/MPEG-4 format or in another format. The encoder module 312 may be based on FFmpeg and may be used to convert and transcode the one or more media components into the finalized media file. In one embodiment, the media file may be encoded in a format that is used for recording, compression, and distribution via the communications network 112.

The encoder module 312 may add animations to the finalized media file such as text that animates at a particular time in the finalized media file or text that fades into the media file at a particular time. The animations may be associated with the media file template. The encoder module 312 also may add watermark information to the finalized media file, particularly if the finalized media file is a free media file.

As noted above, the encoder module 312 may generate the finalized media file having looped background audio for the duration of the media file. In addition, the background audio may be played at an original volume when other audio is not being played. The background audio may be reduced for media components that include audio. As a result, the encoder module 312 may generate a final media file that may include an introduction portion based on the media file template, a user created media portion including the media components (e.g., one or more video media components), and an outro portion based on the media file template. The final media file may have more or less portions.

The automatic media compilation application 306 includes a storage module 314 to store the finalized media file in the database 106 made accessible at a particular URL, e.g., http://play.videofizz.com/fizz/12/34/1234.mp4. This particular URL may be used to access the finalized media file. In addition, the storage module 314 stores associated metadata for the media file and media components received from the client computing devices 102 in the database 106 based on the unique alphanumeric code.

The automatic media compilation application 306 includes a delivery module 316 that delivers information associated with finalized media files to one or more client computing devices 102. When the media file is finalized and stored in the database 106, the delivery module 316 determines a list of one or more recipients such as the producer, the actors, and other recipients and sends a message to each of the one or more recipients. As an example, the finalized media file may be a birthday message including one or more video messages for a person having a birthday on a particular day. On that particular day, the delivery module 316 may send the message to each of the recipients. The message may be a text message, an email message, a push notification, or another type of message that provides the particular URL for the finalized media file. When the client computing device 102 retrieves the particular URL, the client computing device 102 may stream the media file.

The automatic media compilation application 306 includes a user interface module 318. The user interface module 318 receives requests or other communications from the client computing devices 102 and transmits a representation of requested information, user interface elements, and other data and communications to the client computing device 102 for display on the display 220. As an example, the user interface module 318 generates a native and/or web-based graphical user interface (GUI) that accepts input and provides output by generating content that is transmitted via the communications network 112 and viewed by a user of the client computing device 102. The user interface module 318 may provide realtime automatically and dynamically refreshed information to the user of the client computing device 102 using Java, Javascript, AJAX (Asynchronous Javascript and XML), ASP.NET, Microsoft .NET, and/or node.js, among others. The user interface module 318 may send data to other modules of the automatic media compilation application 306 of the server computing device 104, and retrieve data from other modules of the automatic media compilation application 306 of the server computing device 104 asynchronously without interfering with the display and behavior of the automatic media compilation application 206 displayed by the client computing device 102. As an example, data may be retrieved using XMLHttpRequest objects or using WebSockets.

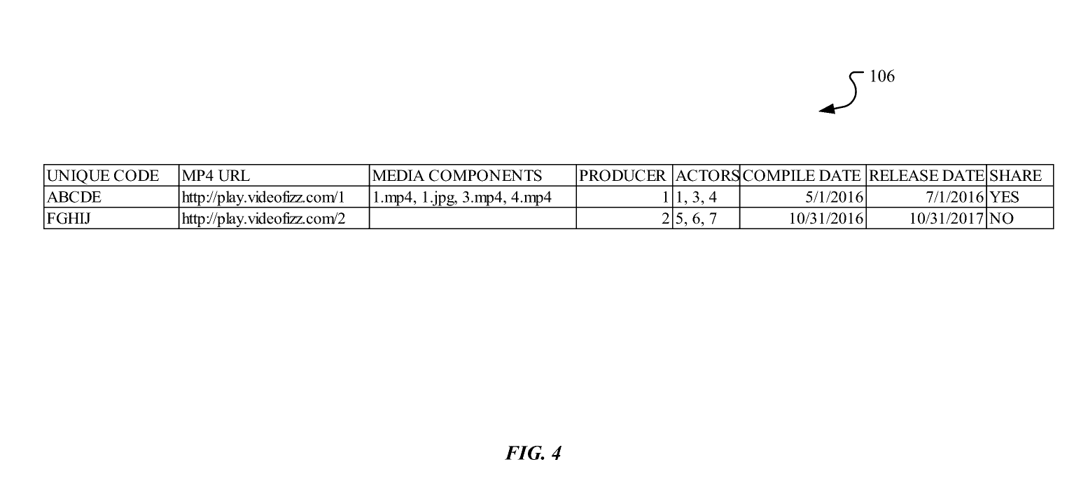

FIG. 4 illustrates an example table of the database 106 of the automatic media compilation system 100 according to an example embodiment. As shown in FIG. 4, each row of the table may store information regarding a media file created by the automatic media compilation system 100. FIG. 4 shows that the database 106 may store a unique code (e.g., the invitation code) for each media file created by the system 100, a particular URL for the finalized media file having the unique code, a list of filenames or other representations of media components associated with the unique code (e.g., the media components may be stored in a media vault), producer information for the media file having the unique code, actor information for the media file having the unique code, a date that the server computing device 104 is to compile the finalized media file, a release date when the server computing device 104 is to deliver information associated with the finalized media file, and whether recipients other than those identified by the producer may view the finalized media file. Other information may be stored in the database 106 such as user account information including username information, password information, contact information (e.g., an email address), and payment information.

Additionally, the database 106 of the automatic media compilation system 100 may include the media vault that may store each of the media files (e.g., videos such as .MP4 files) and media components (e.g., video, audio, photos). The media vault may be separate or part of the database 106.

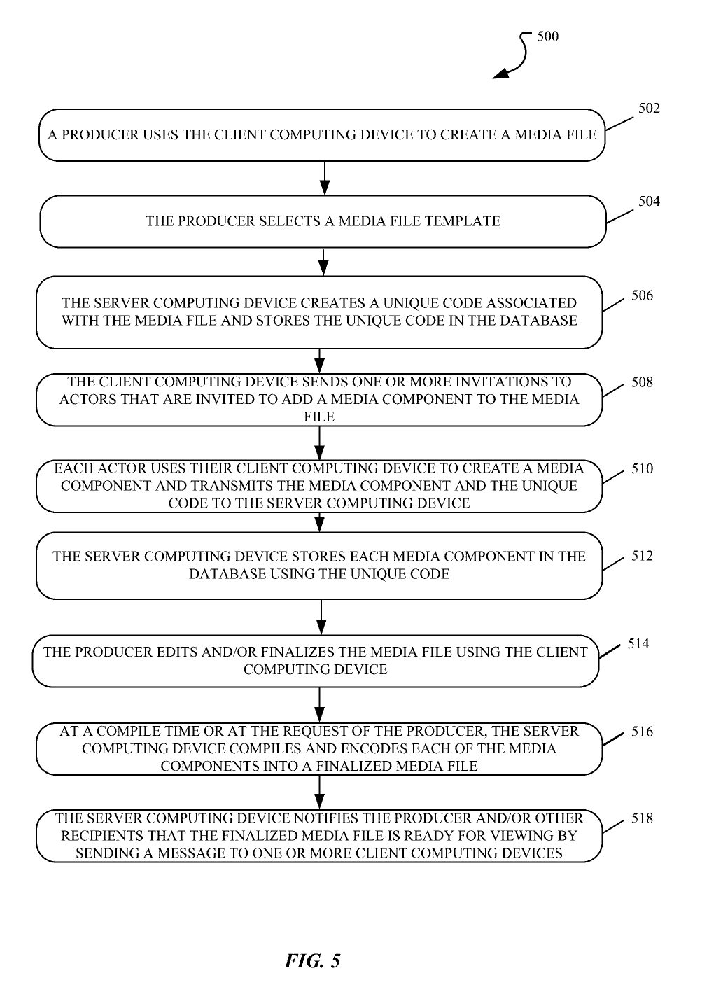

FIG. 5 illustrates a flowchart of a process 500 executed by the automatic media compilation application 206 of the client computing device 102 and the automatic media compilation application 306 of the server computing device 104 for creating a media file. The process 500 shown in FIG. 5 begins at 502.

At 502, a user, e.g., a producer, uses the automatic media compilation application 206 of the client computing device 102 to create a new media file. The producer may create a user account and transmit username and password information to the server computing device 104. The server computing device 104 may store the username and password information in the database 106. After creating the user account, the producer may begin to create the new media file.

At 504, the producer uses the automatic media compilation application 206 to select a media file template from a list of media file templates. The client computing device 102 may transmit a selection of the media file template to the server computing device 104 and the server computing device may store the new media file in the database 106 based on the selected media file template. At 506, when the media file is created, the server computing device 104 may create a unique code (e.g., invitation code) that is associated with the media file and may store the unique code in the database. In addition, the server computing device 104 may transmit the unique code to the client computing device 102. The client computing device 102 may display the unique code on the display 220.

At 508, the producer may use the client computing device 102 to invite one or more other users, e.g., actors, to add one or more media components to the media file. As an example, the producer may send a message to the other users that includes the unique code. The message may also be sent by the server computing device 104.

At 510, each actor may user the client computing device 102 and input the unique code to the automatic media compilation application 206. The automatic media compilation application 206 may transmit the unique code to the server computing device 104 and the server computing device 104 may confirm that the unique code is correct and that the actor is authorized (e.g., invited) to create a media component for the media file. If the actor is authorized, the actor may use the client computing device 102 to capture the media component. The client computing device 102 may capture the media component and transmit the media component and the unique code to the server computing device 104. The server computing device 104 may receive the media component and store the media component in the database 106, e.g., the media vault.

At 512, the server computing device 104 receives the media component and may store the media component in the database 106 by associating the media component with the particular media file having the unique code.

At 514, the producer may edit and/or finalize the media file using the automatic media compilation application 206 of the client computing device 102. The producer may rearrange the order of the media components that were received by the server computing device 104 and/or may delete one or more of the media components. Additionally, the producer may add one or more additional media components and/or may invite other actors to submit media components. The producer also may remind previously invited actors by sending a message to the previously invited actors.

At 516, at the media file compile time or at the request of the producer, the automatic media compilation application 306 of the server computing device 104 may encode the finalized media file and store the finalized media file in the database 106, e.g., the media vault. The finalized media file may be accessible at a particular URL.

At 518, the automatic media compilation application 306 of the server computing device may notify the recipients associated with the finalized media file that the finalized media file is ready for viewing by sending a message to one or more client computing devices 102. The message may include the particular URL associated with the finalized media file. When the client computing device 102 visits the particular URL, the client computing device 102 may stream and view the finalized media file. In addition, the client computing device 102 may store a copy of the finalized media file and if permitted, may share the particular URL of the finalized media file with other recipients.

First, the server computing device 104 may receive a request to create a media file from a first client computing device associated with a producer of the media file and store a representation of the media file in the database 106. The media file may be a birthday media file for a particular recipient. Next, the server computing device 104 may create a unique code that represents the media file and store the unique code in the database 106 with the representation of the media file. The first client computing device and/or the server computing device 104 may send the unique code to actors invited to add a media component to the media file.

The server computing device 104 may receive the unique code and a media component from an actor invited to submit a contribution to the media file. The media component may be sent by a second client computing device that is different from the first client computing device. The server computing device 104 may receive a plurality of different media components from a plurality of client computing devices, e.g., a second client computing device, a third client computing device, a fourth client computing device, and so on. The server computing device 104 may store the media components in the database 106 with the representation of the media file. At a particular time, e.g., on the birthday of the recipient, the server computing device 104 may automatically compile the media components into a final media file and send a notification to a recipient client computing device that the final media file is ready for viewing. The recipient client computing device may be different from the first client computing device and the second client computing device.

Alternatively, before the server computing device 104 automatically compiles the media components into the final media file, the server computing device 104 may receive a request to manage the media file from the first client computing device. The server computing device 104 may transmit a first ordered list of media components associated with the media file to the first client computing device. The producer may reorder the list of media components using the automatic media compilation application 206 and the first client computing device may transmit a second ordered list of media components associated with the media file. The server computing device 104 may receive the second ordered list of media components associated with the media file from the first client computing device. The second ordered list of media components may have more or fewer media components than the first ordered list of media components. There may be fewer if the producer deletes one or more media components. There may be more if the producer creates one or more media components. Before automatically compiling the media components into the final media file, the server computing device 104 may reorder the list of media components based on the second ordered list of media components.

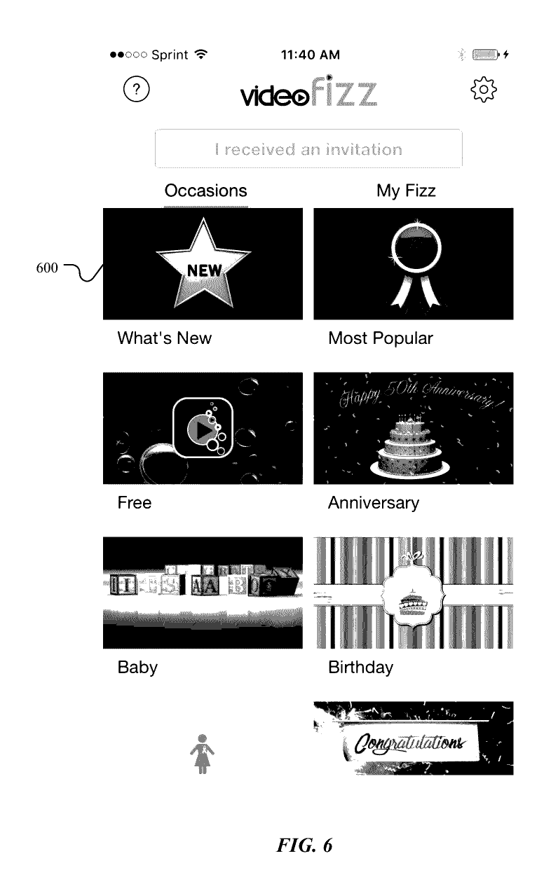

FIG. 6 shows a screenshot 600 of a user interface of the automatic media compilation application 206 displayed on the display 220 of the client computing device 102. The screenshot 600 shows a list of one or more media file templates that may be selected by a producer.

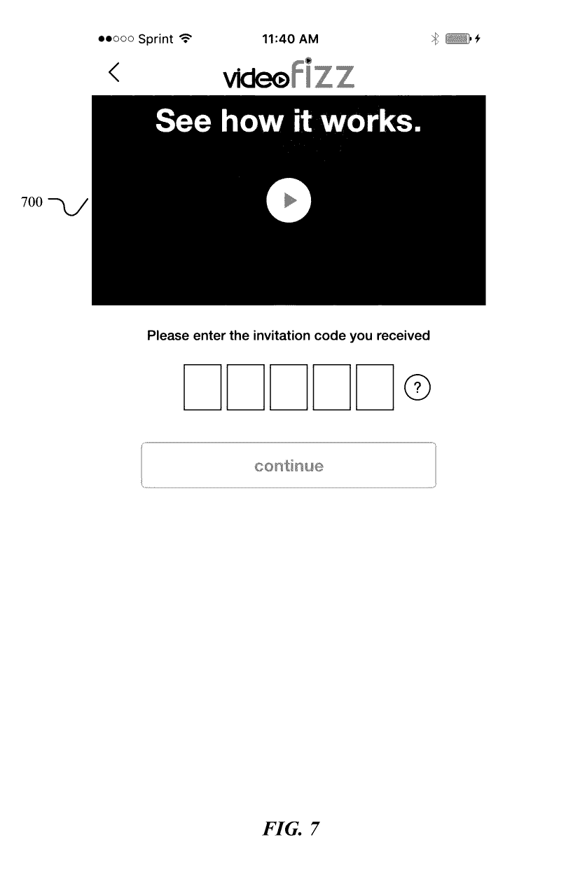

FIG. 7 shows a screenshot 700 of another user interface of the automatic media compilation application 206 displayed on the display 220 of the client computing device 102. The screenshot 700 shows an interface that allows an actor to submit the unique code in order to capture and submit a media component for a particular media file. The user may enter the unique code using the input device 222 and select the “continue” user interface element. If the unique code is a correct unique code and the user is authorized, the user may capture the media component using the imaging device 224.

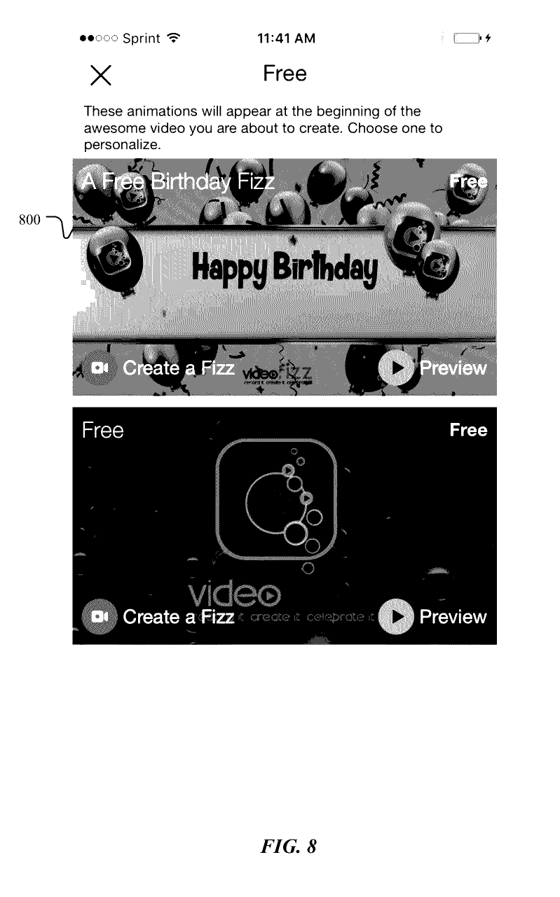

FIG. 8 shows a screenshot 800 of another user interface of the automatic media compilation application 206 displayed on the display 220 of the client computing device 102. The screenshot 800 shows a list of media file templates that are associated with the “Free” category. To begin creating a new media file, the user may select the “Create a Fizz” user interface element.

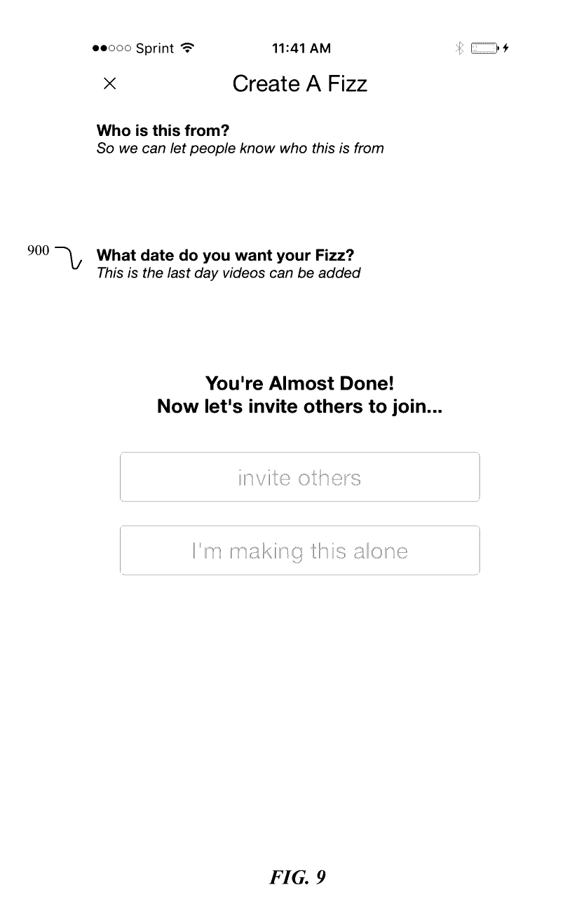

FIG. 9 shows a screenshot 900 of another user interface of the automatic media compilation application 206 displayed on the display 220 of the client computing device 102. The screenshot 900 shows user interface elements associated with the selected media file template. The user may input a name of a creator or producer of the media file and a compile date that indicates when the server computing device 104 may create the finalized media file using the media components associated with the media file and submitted to the server computing device 104.

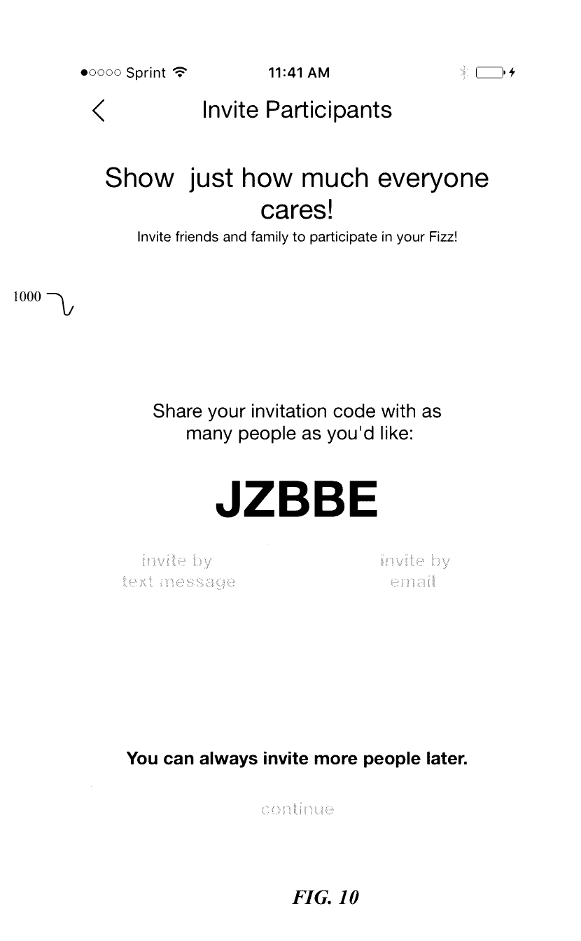

FIG. 10 shows a screenshot 1000 of another user interface of the automatic media compilation application 206 displayed on the display 220 of the client computing device 102. The screenshot 1000 shows user interface elements associated with the media file including the particular unique code for the media file and buttons that allow the user to share the unique code with other actors or participants so that the actors can create and submit media components for the media file to the server computing device 104.

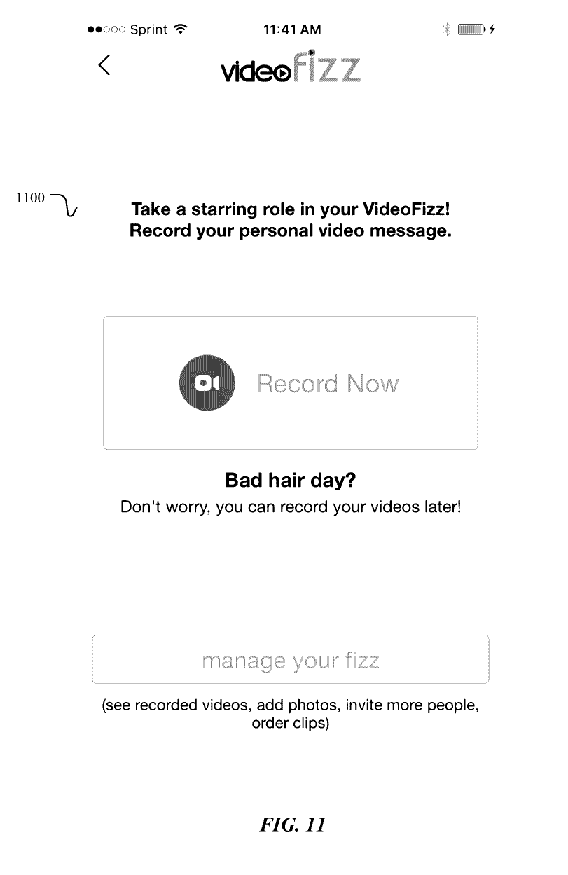

FIG. 11 shows a screenshot 1100 of another user interface of the automatic media compilation application 206 displayed on the display 220 of the client computing device 102. The screenshot 1100 shows user interface elements that may be displayed by the client computing device 102 after the user enters the unique code for the media file and the server computing device 104 determines that the user is authorized to submit a media component. The user may select the “Record Now” button to capture a media component for the media file such as a photo, a video, or another media component and submit the media component to the server computing device 104.

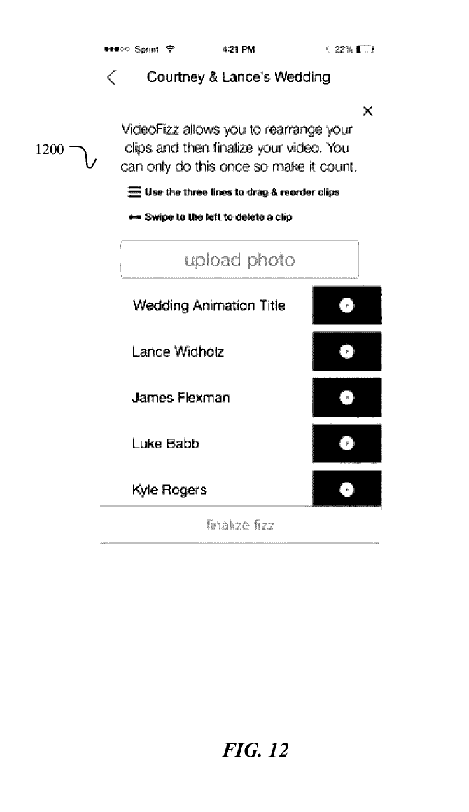

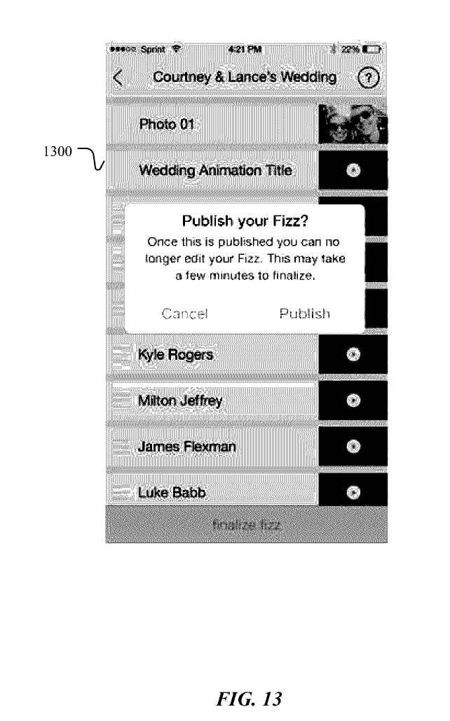

FIGS. 12 and 13 show screenshots 1200 and 1300 of user interfaces of the automatic media compilation application 206 displayed on the display 220 of the client computing device 102. The screenshots 1200 and 1300 show user interface elements that allow the producer of the media file to manage and finalize the media components associated with the media file. As an example, each of the media components may be reordered and/or deleted by the producer. When the producer selects “finalize fizz,” the server computing device 104 may encode, finalize, store the finalized media file in the database 106, and publish the finalized media file for viewing by the recipients of the media file. The server computing device 104 may send a particular URL associated with the finalized media file to the recipients.

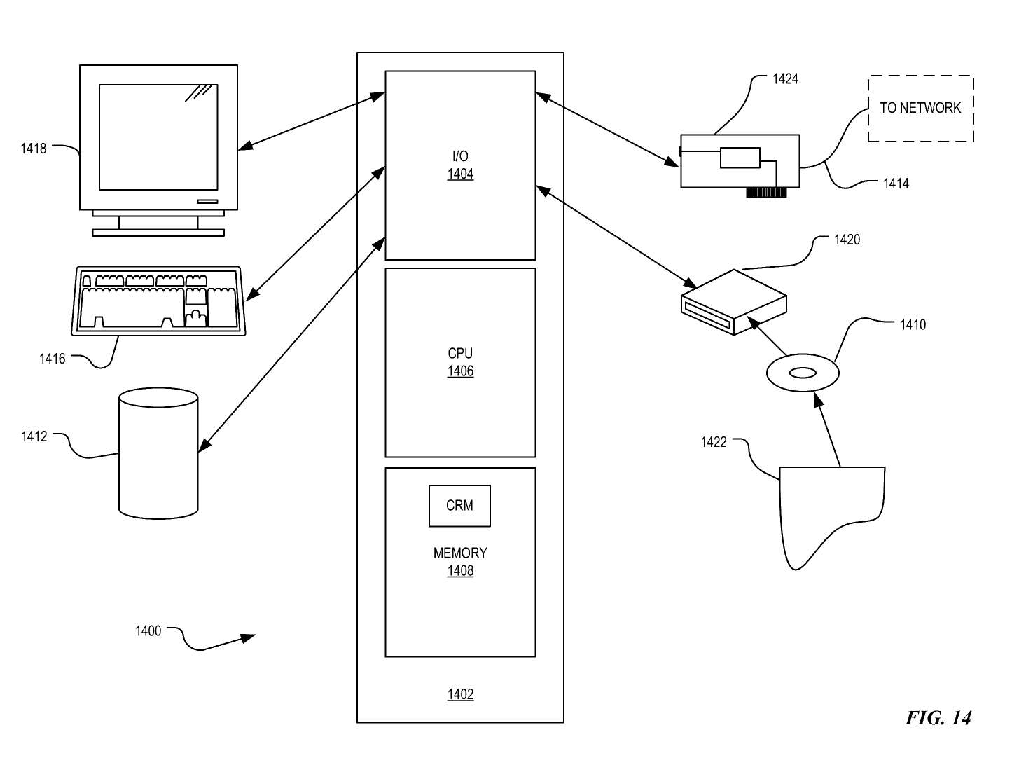

FIG. 14 illustrates an example computing system 1400 that may implement various systems, such as the client computing device 102 and the server computing device 104, and the methods discussed herein, such as process 500. A general purpose computer system 1400 is capable of executing a computer program product to execute a computer process. Data and program files may be input to the computer system 1400, which reads the files and executes the programs therein such as the client component of the automatic media compilation application 206 and the server component of the automatic media compilation application 306. Some of the elements of a general purpose computer system 1400 are shown in FIG. 14 wherein a processor 1402 is shown having an input/output (I/O) section 1404, a central processing unit (CPU) 1406, and a memory section 1408. There may be one or more processors 1402, such that the processor 1402 of the computer system 1400 comprises a single central-processing unit 1406, or a plurality of processing units, commonly referred to as a parallel processing environment. The computer system 1400 may be a conventional computer, a server, a distributed computer, or any other type of computer, such as one or more external computers made available via a cloud computing architecture. The presently described technology is optionally implemented in software devices loaded in memory 1408, stored on a configured DVD/CD-ROM 1410 or storage unit 1412, and/or communicated via a wired or wireless network link 1414, thereby transforming the computer system 1400 in FIG. 14 to a special purpose machine for implementing the described operations.

The memory section 1408 may be volatile media, nonvolatile media, removable media, non-removable media, and/or other media or mediums that can be accessed by a general purpose or special purpose computing device. For example, the memory section 1408 may include non-transitory computer storage media and communication media. Non-transitory computer storage media further may include volatile, nonvolatile, removable, and/or non-removable media implemented in a method or technology for the storage (and retrieval) of information, such as computer/machine-readable/executable instructions, data and data structures, engines, program modules, and/or other data. Communication media may, for example, embody computer/machine-readable/executable, data structures, program modules, algorithms, and/or other data. The communication media may also include an information delivery technology. The communication media may include wired and/or wireless connections and technologies and be used to transmit and/or receive wired and/or wireless communications.

The I/O section 1404 is connected to one or more user-interface devices (e.g., a keyboard 1416 and a display unit 1418), a disc storage unit 1412, and a disc drive unit 1420. Generally, the disc drive unit 1420 is a DVD/CD-ROM drive unit capable of reading the DVD/CD-ROM medium 1410, which typically contains programs and data 1422. Computer program products containing mechanisms to effectuate the systems and methods in accordance with the presently described technology may reside in the memory section 1404, on a disc storage unit 1412, on the DVD/CD-ROM medium 1410 of the computer system 1400, or on external storage devices made available via a cloud computing architecture with such computer program products, including one or more database management products, web server products, application server products, and/or other additional software components. Alternatively, a disc drive unit 1420 may be replaced or supplemented by a floppy drive unit, a tape drive unit, or other storage medium drive unit. The network adapter 1424 is capable of connecting the computer system 1400 to a network via the network link 1414, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 1400 is connected (by wired connection and/or wirelessly) to a local network through the network interface or adapter 1424, which is one type of communications device. When used in a WAN-networking environment, the computer system 1400 typically includes a modem, a network adapter, or any other type of communications device for establishing communications over the wide area network. In a networked environment, program modules depicted relative to the computer system 1400 or portions thereof, may be stored in a remote memory storage device. It is appreciated that the network connections shown are examples of communications devices for and other means of establishing a communications link between the computers may be used.

In an example implementation, source code executed by the client computing device 102, and the server computing device 104, a plurality of internal and external databases, source databases, and/or cached data on servers are stored in the database 106, memory of the client computing device 102, memory of the server computing device 104, or other storage systems, such as the disk storage unit 1412 or the DVD/CD-ROM medium 1410, and/or other external storage devices made available and accessible via a network architecture. The source code executed by the client computing device 102 and the server computing device 104 may be embodied by instructions stored on such storage systems and executed by the processor 1402.

Some or all of the operations described herein may be performed by the processor 1402, which is hardware. Further, local computing systems, remote data sources and/or services, and other associated logic represent firmware, hardware, and/or software configured to control operations of the automatic media compilation system 100 and/or other components. Such services may be implemented using a general purpose computer and specialized software (such as a server executing service software), a special purpose computing system and specialized software (such as a mobile device or network appliance executing service software), or other computing configurations. In addition, one or more functionalities disclosed herein may be generated by the processor 1402 and a user may interact with a Graphical User Interface (GUI) using one or more user-interface devices (e.g., the keyboard 1416, the display unit 1418, and the user devices 1404) with some of the data in use directly coming from online sources and data stores. The system set forth in FIG. 14 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon executable instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic executable instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system comprising:
a memory; and
at least one processor to execute instructions stored in the memory to perform operations comprising:
receiving a request to create a media file from a first client computing device associated with a producer of the media file and storing a representation of the media file in a database;
creating a unique code that represents the media file and storing the unique code in the database with the representation of the media file;
receiving the unique code and a media component from an actor invited to submit a contribution to the media file, the media component sent by a second client computing device;
storing the media component in the database with the representation of the media file;
automatically compiling the media component into a final media file; and
sending a notification to a recipient client computing device that the final media file is ready for viewing.

2. The system of claim 1, the media component comprising a first media component, the actor comprising a first actor, the operations further comprising:
receiving the unique code and a second media component from a second actor invited to submit a contribution to the media file, the second media component sent by a third client computing device.

3. The system of claim 2, the operations further comprising:
receiving the unique code and a third media component from a third actor invited to submit a contribution to the media file, the third media component sent by a fourth client computing device.

4. The system of claim 1, the operations further comprising:
receiving a release date from the first client computing device;
automatically compiling the media component into the final media file on the release date; and
sending the notification to the recipient client computing device on the release date.

5. The system of claim 1, the operations further comprising:
sending a particular uniform resource locator (URL) of the final media file with the notification.

6. The system of claim 5, the operations further comprising:
receiving the particular uniform resource locator (URL) of the final media file from the recipient client computing device and streaming the final media file to the recipient client computing device.

7. The system of claim 1, the operations further comprising:
receiving a request to manage the media file from the first client computing device;
transmitting a first ordered list of media components associated with the media file to the first client computing device;
receiving a second ordered list of media components associated with the media file from the first client computing device; and
reordering the list of media components based on the second ordered list of media components.

8. The system of claim 1, the operations further comprising:
receiving a request to manage the media file from the first client computing device;
transmitting a first ordered list of media components associated with the media file to the first client computing device;
receiving a second ordered list of media components associated with the media file from the first client computing device, the second ordered list of media components having fewer media components than the first ordered list of media components; and
reordering the list of media components based on the second ordered list of media components.

9. The system of claim 1, the operations further comprising:
encoding the final media file using H.264.

10. The system of claim 1, the operations further comprising:
receiving a selection of a media file template and generating the media file based on the media file template.

11. A method comprising:
receiving, by at least one processor, a request to create a media file from a first client computing device associated with a producer of the media file and storing a representation of the media file in a database;
creating, by the at least one processor, a unique code that represents the media file and storing the unique code in the database with the representation of the media file;
receiving, by the at least one processor, the unique code and a media component from an actor invited to submit a contribution to the media file, the media component sent by a second client computing device;
storing, by the at least one processor, the media component in the database with the representation of the media file;
automatically compiling, by the at least one processor, the media component into a final media file; and
sending, by the at least one processor, a notification to a recipient client computing device that the final media file is ready for viewing.

12. The method of claim 11, the media component comprising a first media component, the actor comprising a first actor, the method further comprising:
receiving the unique code and a second media component from a second actor invited to submit a contribution to the media file, the second media component sent by a third client computing device.

13. The method of claim 12, further comprising:
receiving the unique code and a third media component from a third actor invited to submit a contribution to the media file, the third media component sent by a fourth client computing device.

14. The method of claim 11, further comprising:
receiving a release date from the first client computing device;
automatically compiling the media component into the final media file on the release date; and
sending the notification to the recipient client computing device on the release date.

15. The method of claim 11, further comprising:
sending a particular uniform resource locator (URL) of the final media file with the notification.

16. The method of claim 15, further comprising:
receiving the particular uniform resource locator (URL) of the final media file from the recipient client computing device and streaming the final media file to the recipient client computing device.

17. The method of claim 11, further comprising:
receiving a request to manage the media file from the first client computing device;
transmitting a first ordered list of media components associated with the media file to the first client computing device;
receiving a second ordered list of media components associated with the media file from the first client computing device; and
reordering the list of media components based on the second ordered list of media components.

18. The method of claim 11, further comprising:
receiving a request to manage the media file from the first client computing device;
transmitting a first ordered list of media components associated with the media file to the first client computing device;
receiving a second ordered list of media components associated with the media file from the first client computing device, the second ordered list of media components having fewer media components than the first ordered list of media components; and
reordering the list of media components based on the second ordered list of media components.

19. The method of claim 11, further comprising:
encoding the final media file using H.264.

20. The method of claim 11, further comprising:
receiving a selection of a media file template and generating the media file based on the media file template.

21. A non-transitory computer-readable medium having instructions stored thereon that, when executed by at least one processor, cause the at least one processor to perform operations comprising:
receiving a request to create a media file from a first client computing device associated with a producer of the media file and storing a representation of the media file in a database;
creating a unique code that represents the media file and storing the unique code in the database with the representation of the media file;
receiving the unique code and a media component from an actor invited to submit a contribution to the media file, the media component sent by a second client computing device;
storing the media component in the database with the representation of the media file;
automatically compiling the media component into a final media file; and
sending a notification to a recipient client computing device that the final media file is ready for viewing.
